(19) United States
(12) Patent Application Publication
(10) Pub. No.: US 2015/0022148 A1
(43) Pub. Date: Jan. 22, 2015

(54) ELECTROCHEMICAL CELL LABELS AND ACCESSORIES

(71) Applicant: AVERY DENNISON CORPORATION, Pasadena, CA (US)

(72) Inventors: Paul Janousek, Simpsonville, SC (US); Valdis Barnett, Simpsonville, SC (US); Dirk Lovelace, Spartansburg, SC (US); Anne Shim, Hudson, OH (US)

(21) Appl. No.: 14/374,082

(22) PCT Filed: Jan. 23, 2013
(86) PCT No.: PCT/US2013/022675

§ 371 Date: Jul. 23, 2014

Related U.S. Application Data
(60) Provisional application No. 61/589,676, filed on Jan. 23, 2012.
(60) Provisional application No. 61/601,600, filed on Feb. 22, 2012.

(51) Int. Cl. H02J 7/02; H02J 7/00

(52) U.S. Cl. CPC H02J 7/025; H02J 7/0047; H02J 7/0057; H02J 2007/005; H04B 1/3883
USPC 320/108

(57) ABSTRACT

A battery includes a first terminal, a second terminal, body connecting the first and second terminals, and an outer layer or label. The label may be provided with a power indicator apparatus and a visual charge indicator having improved visibility. The label may alternatively or additionally be provided with a plurality of visual charge indicators and/or other features and functionality, including sensory features that appeal to the sense of touch and/or sight. The label may further or alternatively include a circuit or antenna configured to receive a signal from a charger and convert it into energy or charge stored within the battery.

### CROSS-REFERENCE TO RELATED APPLICATIONS

The present application claims the benefit of U.S. Provisional Patent Application No. 61/589,676, filed Jan. 23, 2012, and U.S. Provisional Patent Application No. 61/601,600, filed Feb. 22, 2012, which are incorporated herein by reference in their entireties.

### DESCRIPTION TECHNICAL FIELD

The present subject matter relates to electrochemical cells. More particularly, the present subject matter relates to labels for electrochemical cells, labels with enhanced effects for use with electrochemical cells, and accessories for use with electrochemical cells, such as charging devices.

### BACKGROUND

Electrochemical cells such as batteries are common sources of electrical power for many consumer, commercial, and industrial applications. Batteries are often purchased and stored for periods of time before being used. During these periods of storage, the energy or charge stored in a battery can partially or fully dissipate. Therefore, a battery can have a finite shelf life. Accordingly, it would be advantageous to provide means by which a consumer may readily determine if a battery has any charge remaining and/or how much charge remains in the battery. It would also be advantageous to provide means by which a consumer may recharge a battery having insufficient energy stored therein. Furthermore, it would be advantageous to provide a battery having a label with additional functionality and/or utility beyond that of known battery labels. It would further be advantageous to provide a label for an electrochemical cell which has enhanced sensory effects to further enhance one or both of sight and touch related elements of the label after application to an electrochemical cell.

### SUMMARY

There are several aspects of the present subject matter which may be embodied separately or together in the devices and systems described and claimed below. These aspects may be employed alone or in combination with other aspects of the subject matter described herein, and the description of these aspects together is not intended to preclude the use of these aspects separately or the claiming of such aspects separately or in different combinations as may be set forth in the claims appended hereto.

In one aspect, a battery assembly label is provided with a power indicator apparatus and a visual charge indicator having improved visibility.

In another aspect, a battery assembly label is provided with a power indicator apparatus and a plurality of visual charge indicators.

In yet another aspect, a battery assembly label is provided with a quick response code.

In another aspect, a battery assembly label is provided with a security feature.

In yet another aspect, a battery assembly label is provided with a sealant or absorbent feature.

In another aspect, a battery assembly label is provided with an open or designated area.

In yet another aspect, a battery assembly label is provided with a tamper-resistant extension configured to at least partially surround one of the end caps of an associated battery.

In another aspect, a rechargeable battery assembly label is provided with a printed circuit or antenna and a printed insulator or bridge associated with the circuit or antenna.

In yet another aspect, a recharging pad is provided for use in combination with a rechargeable battery assembly. The recharging pad is configured to emit a signal receivable by a circuit or antenna of a label of a rechargeable battery assembly.

In another aspect, a display unit is provided for use in combination with a rechargeable battery assembly. The display unit includes a recharging pad configured to emit a signal receivable by a circuit or antenna of a label of a rechargeable battery assembly.

A further aspect of the invention is to provide a label for an electrochemical cell which has enhanced sensory elements relating to touch and sight, wherein those sensory elements are retained by the label after application to an electrochemical cell.

### BRIEF DESCRIPTION OF THE DRAWINGS

FIG. 1 is a schematic view depicting a battery assembly in accordance with one embodiment;

FIG. 2 is a schematic view depicting the battery assembly of FIG. 1 having an outer layer partially unassembled from the battery assembly to reveal a battery and a power indicator apparatus;

FIG. 3A is a plan view depicting the functional components of the power indicator apparatus of FIG. 2;

FIG. 3B is a plan view depicting an electrical conductor of the power indicator apparatus of FIG. 3A;

FIG. 3C is a plan view depicting a mechanical switch of the power indicator apparatus of FIG. 3A;

FIGS. 3D-3K illustrate alternative embodiments of the electrical conductor of FIG. 3B;

FIG. 4 is a plan view depicting the battery assembly of FIG. 1 partially unassembled, revealing the outer layer and the power indicator apparatus positioned adjacent to the battery;

FIG. 5 is a perspective view depicting the battery of FIG. 1 having the outer layer only partially assembled;

FIG. 6 is a perspective view depicting an operator initiating a reading of potential energy stored in the battery assembly of FIG. 1;

FIG. 6A is a cross-sectional view of the battery assembly of FIG. 6 prior to an operator initiating a reading of potential energy stored therein;

FIG. 6B is a cross-sectional view of the battery assembly of FIG. 6 during an operator-initiated reading of potential energy stored therein;

FIGS. 7-11 are plan views of labels incorporating a visual charge indicator that may be used in combination with batteries of the present disclosure;

FIG. 12 is a perspective view of a battery assembly incorporating the label of FIG. 11;

FIG. 13 is a plan view of another embodiment of a label incorporating a visual charge indicator that may be used in combination with batteries of the present disclosure;

FIG. 14 is a perspective view of a battery assembly incorporating the label of FIG. 13;

FIG. 15 is a plan view of another embodiment of a label incorporating a visual charge indicator that may be used in combination with batteries of the present disclosure;

FIG. 16 is a perspective view of a battery assembly incorporating the label of FIG. 15;

FIG. 17 is a plan view of another embodiment of a label incorporating a visual charge indicator that may be used in combination with batteries of the present disclosure;

FIG. 18 is a perspective view of a battery assembly incorporating the label of FIG. 17;

FIG. 19 is a plan view of a label incorporating a visual charge indicator that may be used in combination with rechargeable batteries of the present disclosure;

FIGS. 20-22 are plan views of a label incorporating a plurality of visual charge indicators that may be used in combination with batteries of the present disclosure;

FIG. 23 is a plan view of a label incorporating a quick response code that may be used in combination with batteries of the present disclosure;

FIG. 24 is a plan view of a label incorporating a security feature that may be used in combination with batteries of the present disclosure;

FIG. 25 is a plan view of a label incorporating a sealant feature that may be used in combination with batteries of the present disclosure;

FIG. 26 is a plan view of a label incorporating an open or designated area that may be used in combination with batteries of the present disclosure;

FIG. 27 is a plan view of a label incorporating a freshness or tamper-resistant extension that may be used in combination with batteries of the present disclosure;

FIG. 28 is a side elevational view of a battery assembly incorporating the label of FIG. 27;

FIGS. 29-31 are plan views of a label incorporating a printed circuit or antenna that may be used in combination with rechargeable battery assemblies of the present disclosure;

FIG. 32 is a perspective view of a pad or charger that may be used in combination with rechargeable battery assemblies of the present disclosure;

FIG. 33 is a front elevational view of a package or container for holding one or more rechargeable battery assemblies of the present disclosure; and

FIG. 34 is a front elevational view of a display unit for holding one or more of the packages of FIG. 33 and for point of purchase charging.

### DETAILED DESCRIPTION OF THE ILLUSTRATED EMBODIMENTS

The embodiments disclosed herein are exemplary only, and the subject matter described herein may be embodied in various forms. Therefore, specific details disclosed herein are not to be interpreted as limiting the subject matter as defined in the accompanying claims.

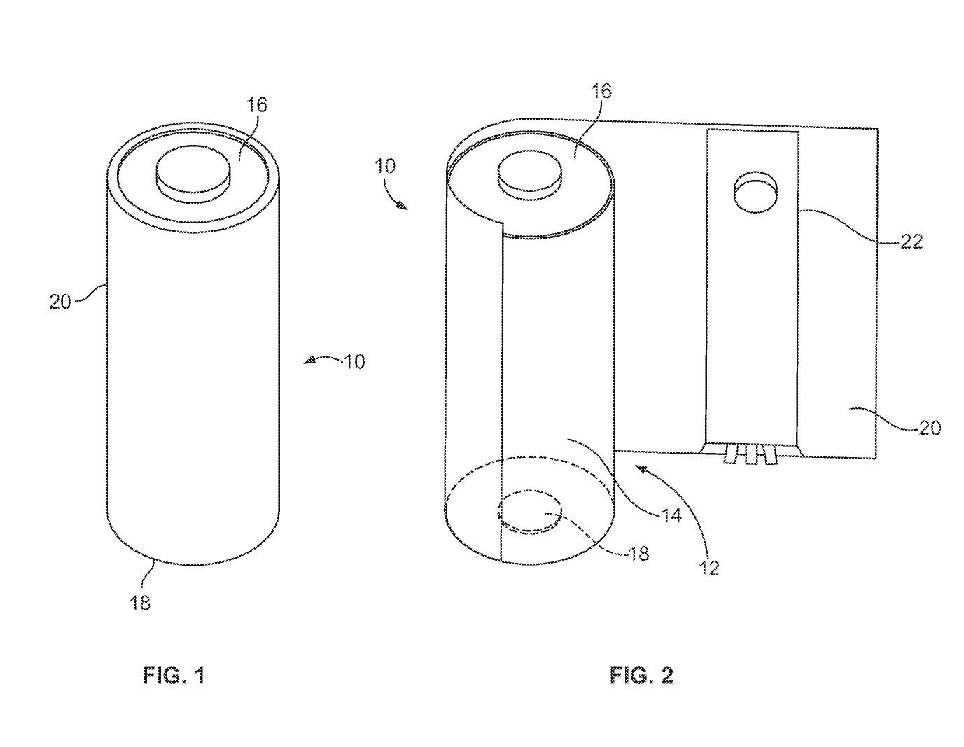

A common source of portable electrical energy that uses one or more electrochemical cells is a dry cell battery. Dry cell batteries can be manufactured and sold in a variety of sizes, configurations, and voltage outputs. For example, common types of consumer batteries are marketed and known as “AA-type,” “AAA-type,” “C-type,” “D-type,” “9-volt-type,” and so on. As illustrated in FIGS. 1 and 2, a battery assembly 10 can comprise a battery 12, an outer layer or label 20, and a power indictor apparatus 22. The battery 12 may include a cylindrical casing 14, a first end cap 16, and a second end cap 18. The first end cap 16 may at least partially seal a first open end of the casing 14, and the second end cap 18 may at least partially seal a second and opposing open end of the casing 14. Chemicals or other active elements or components used to produce electrical power can be stored within and enclosed by the casing 14, the first end cap 16, and the second end cap 18.

The casing 12, first end cap 14, and second end cap 16 may be joined to form the battery 12. The label 20 may then be wrapped to at least partially cover the battery 12. In one example, the label 20 may be arranged so that it covers the casing 14 and at least a portion of the first end cap 16 and/or a portion of the second end cap 18. The label 20 may include any of a variety of suitable materials or substances. In one example, the label 20 may comprise a relatively thin sheet or film of polyethylene terephthalate (PET). In another example, the label 20 may comprise a relatively thin sheet or film of a PET copolymer such as PET modified by adding cyclohexane dimethanol to the polymer backbone in place of ethylene glycol to form PETG. As will be further discussed, the label 20 may be a shrink-wrap polymeric film. In such a configuration, heat can be applied to the polymeric film, thereby causing the film to contract or shrink to the outer shape and/or contours of the battery 12. In another embodiment, the label 20 may include PVC (polyvinyl chloride) and a polyolefin comprising a polypropylene and polyethylene blend (PP/PE).

The first end cap 16 and the second end cap 18 may be arranged as polar terminals for the battery 12. The first and second end caps 16 and 18 may further be arranged to be polar opposites. In other words, the first end cap 16 may be arranged to be a positive terminal for the battery 12, and the second end cap 18 may be arranged to be a negative terminal for the battery 12. Conversely, the first end cap 16 may be arranged to be the negative terminal, and the second end cap 18 may be arranged to be the positive terminal. It will be understood that any reference to “first end cap” and “second end cap” in this document should not be read to limit such a reference to either a component of a positive terminal or a component of a negative terminal. Furthermore, it will be understood that any reference to “first terminal” and “second terminal” in this document should not be read to limit such a reference to either a positive terminal or a negative terminal.

It will be understood that the casing 14 may also be arranged to form part of a terminal as well. In one example, the first end cap 16 and at least a portion of the casing 14 may comprise the positive terminal and the second end cap 18 may comprise the negative terminal. In such an arrangement, when a conductive material is positioned in contact with the positive terminal (i.e., the first end cap 16 or the casing 14) and in contact with the negative terminal (i.e., the second end cap 18), a circuit can be completed and an electrical current can pass though the conductive material. In another example, the casing 14 may comprise the negative terminal (along with the second end cap 18), with the first end cap 16 comprising the positive terminal. In this configuration, when a conductive material is positioned in contact with the positive terminal (i.e., the first end cap 16) and in contact with the negative terminal (i.e., the second end cap 18 or the casing 14), a circuit can be completed and an electrical current can pass through the conductive material.

The label 20 may be configured to serve a number of functions. In one example, the label 20 may include graphics and/or text to provide an informational and/or marketing function for the battery assembly 10. For example, the label 20 may include the name and logo of the battery manufacturer and/or the type and voltage of the battery assembly 10. Additionally or alternatively, as further discussed below, the label 20 may facilitate access to an interactive display that selectively indicates the amount of energy remaining in the battery assembly 10. In one example, an adhesive layer may be provided to secure the label 20 to the battery 12.

As previously discussed, the label 20 may comprise a polymeric shrink-wrap film that conforms to the shape and/or contours of the battery 12 upon the application of heat. In such an arrangement, additional layers of material or generally thin apparatus or assemblies may be positioned between the label 20 and the battery 12 prior to the application of heat to the label 20. Upon the application of heat to the label 20, the shrinking and conforming of the label 20 can position and/or secure such additional layers or assemblies relative to the battery 12.

In one example illustrated in FIG. 2, a power indicator apparatus 22 may be positioned between the label 20 and the battery 12. The label 20 may be configured to display the remaining charge in a two-touch configuration or a one-touch configuration, as will be described in greater detail herein. When the label 20 is heated and conforms to the shape of the battery 12, the power indicator apparatus 22 may be positioned and secured so that the power indicator apparatus 22 is arranged to be in electrical communication with at least one of the casing 14, first end cap 16, or second end cap 18. As will be further detailed, the power indicator apparatus 22 can be arranged so that a user of the battery assembly 10 may selectively actuate the power indicator apparatus 22 to determine the amount of energy remaining in the battery assembly 10. In addition, the power indicator apparatus 22 can be arranged so that a user can selectively actuate the power indicator apparatus 22 by applying pressure at a predetermined location along the label 20.

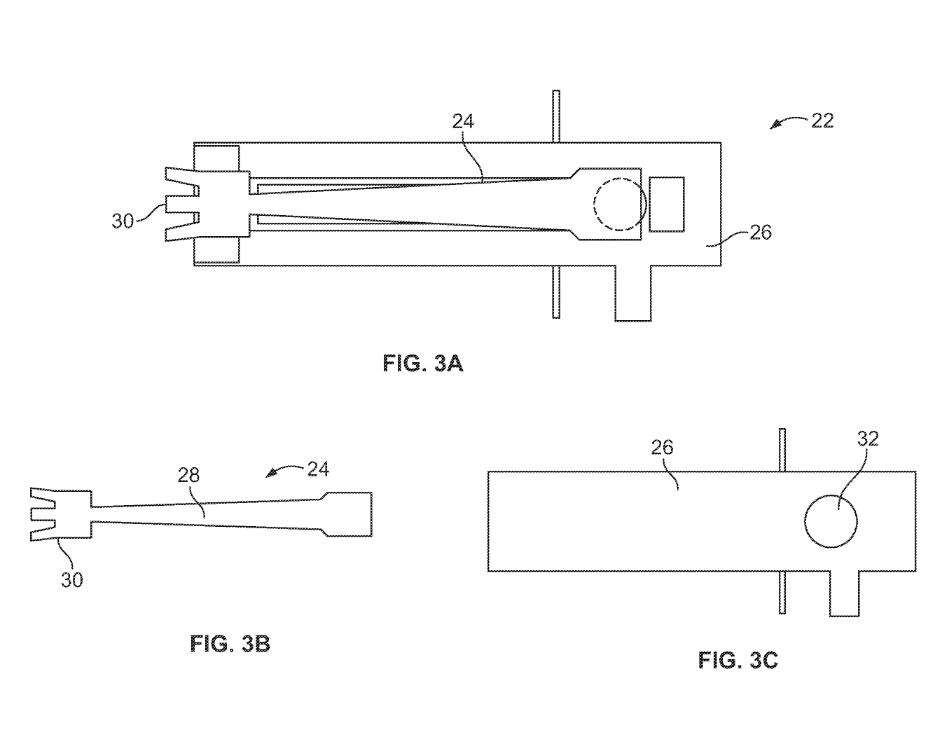

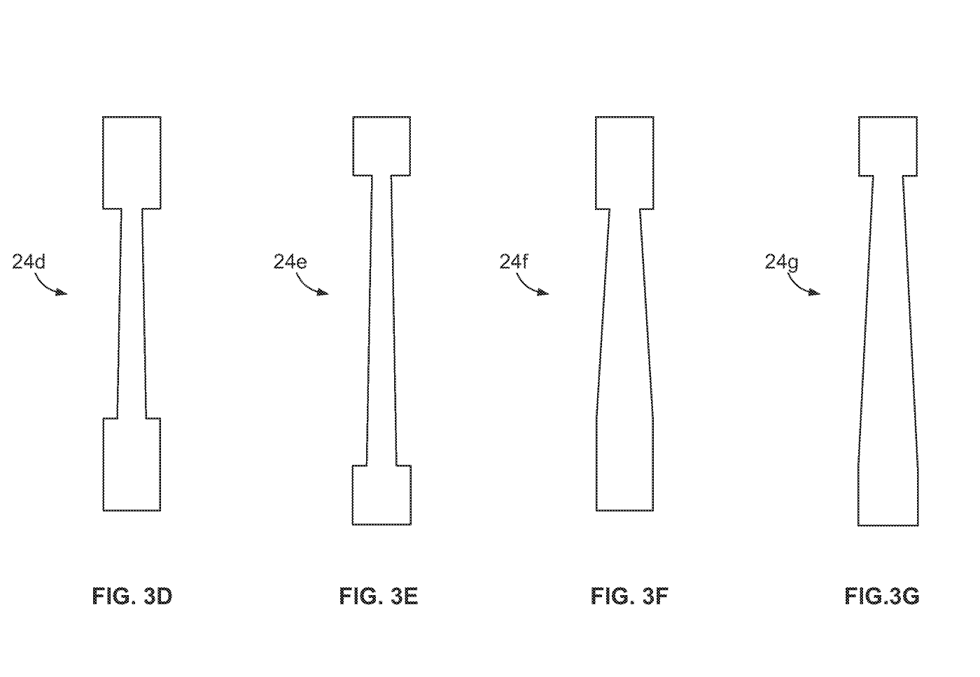

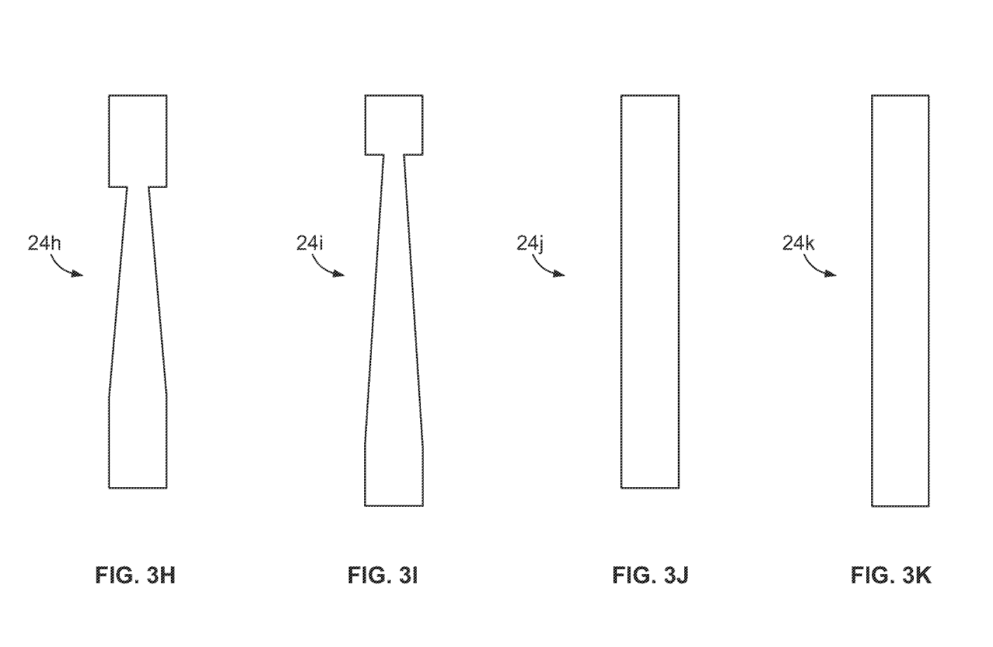

An example of a power indicator apparatus 22 is illustrated in FIG. 3A. The power indicator apparatus 22 may include an electrical conductor 24 and a mechanical switch 26. As shown in FIG. 3B, the electrical conductor 24 may include a tapered body 28 and features 30, such as tabs or posts, extending from one end of the electrical conductor 24. The electrical conductor 24 may be made from any of a variety of suitable electrically conductive materials such as, for example, silver, copper, gold, and the like. An exemplary mechanical switch 26 is illustrated in greater detail in FIG. 3C. The material forming the mechanical switch 26 may have insulative properties so that when the mechanical switch 26 is positioned adjacent to the electrical conductor 24, the mechanical switch 26 can generally insulate all or a portion of the electrical conductor 24 from other components of the battery assembly 10, such as the battery 12.

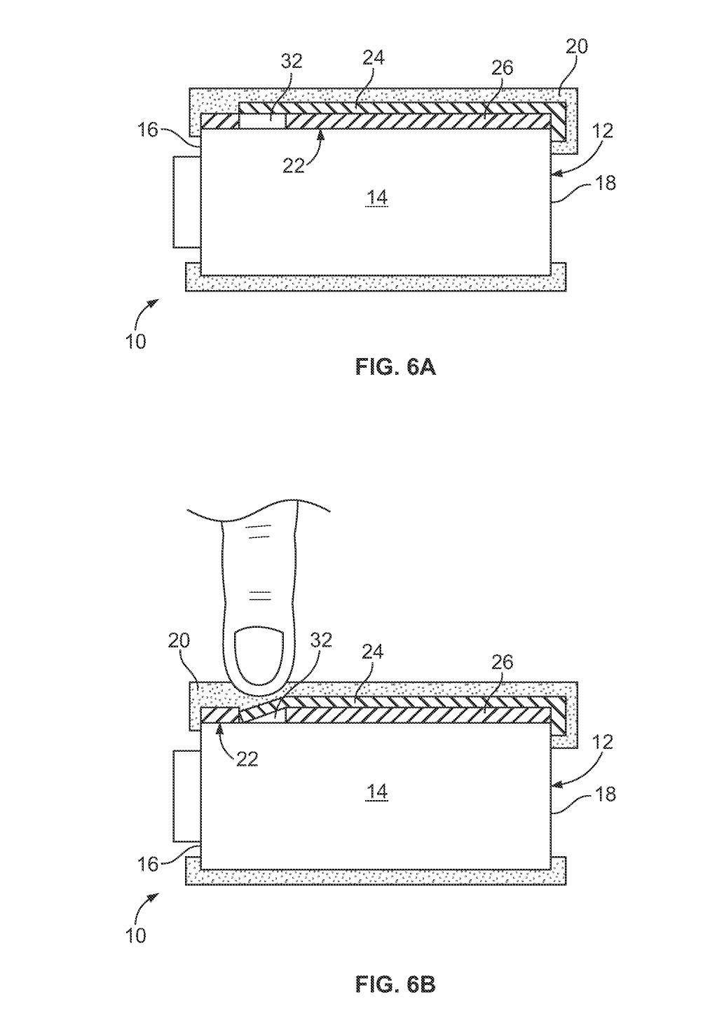

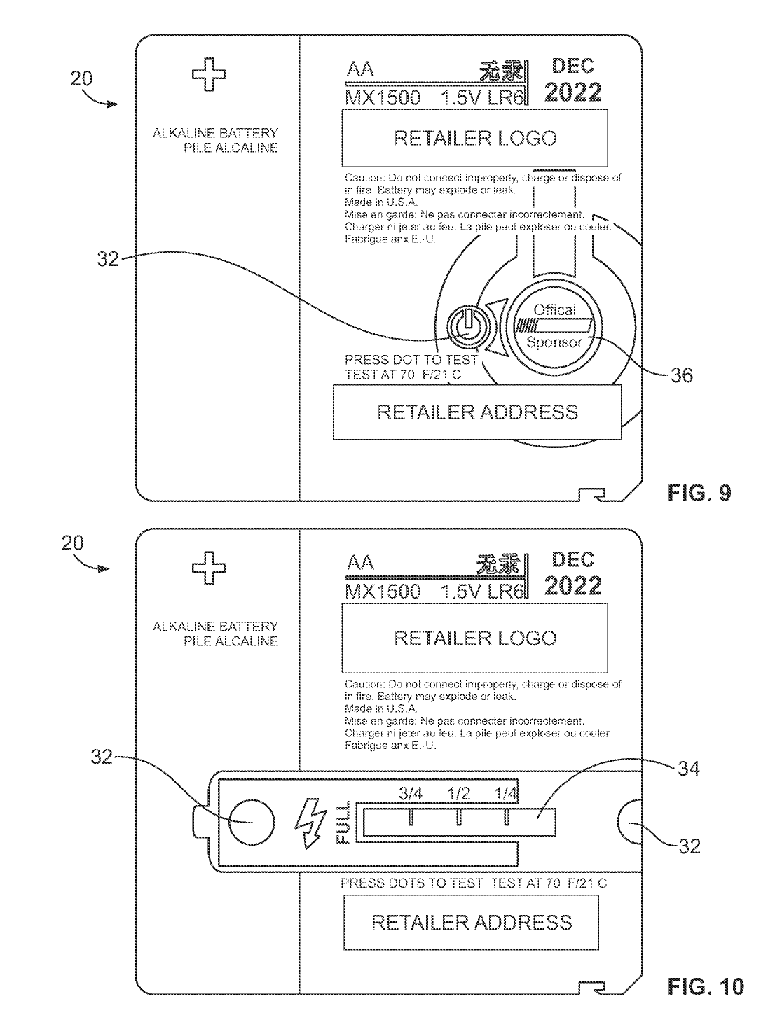

The mechanical switch 26 may include at least one aperture 32 (FIG. 3C) through which the electrical conductor 24 may be selectively engaged with proximate or adjacent components. As illustrated in FIG. 3A, a portion of the electrical conductor 24 may be positioned over the aperture 32. Once the battery assembly 10 is assembled, pressure can be applied through the label 20 at or near the aperture 32 to temporarily deform the electrical conductor 24 and/or the mechanical switch 26 and allow electrical communication between the electrical conductor 24 and the battery 12 through the aperture 32. If the mechanical switch 26 includes only one aperture 32 (FIGS. 6-9), a user may apply one-touch pressure to the aperture 32 to actuate the power indicator apparatus 22. If the mechanical switch 26 includes two apertures 32 (FIGS. 10-22), a user may apply pressure to both apertures 32 (i.e., two-touch pressure) to actuate the power indicator apparatus 22. It will be understood that mechanisms such as, for example, leaf springs, cantilevers, detents, resilient materials, cardboard insulators, and the like may be incorporated into the electrical conductor 24 and/or the mechanical switch 26 to facilitate selective electrical communication through the application of pressure on or near the power indicator apparatus 22.

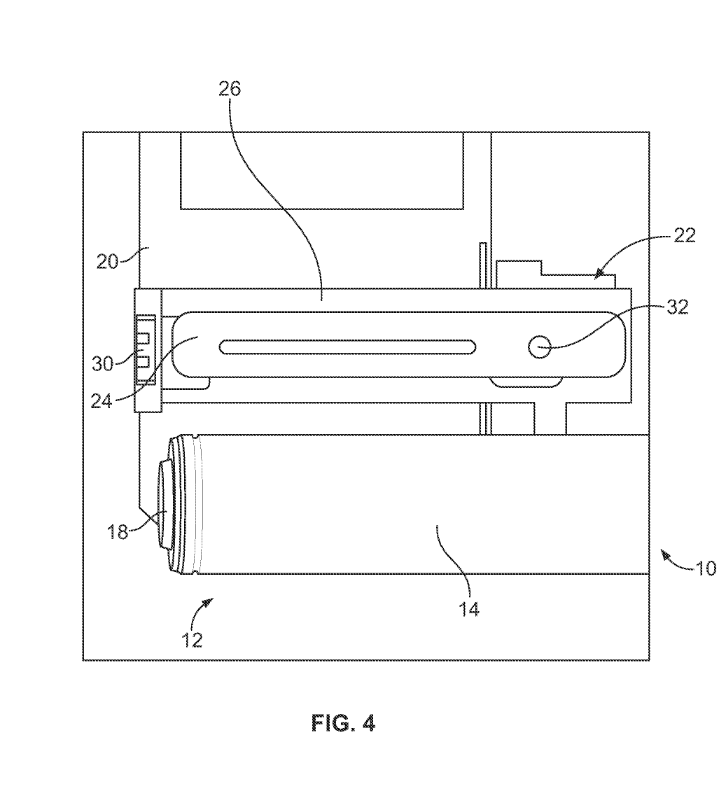

As previously discussed, the power indicator apparatus 22 may be positioned proximate or adjacent to the battery 12. As illustrated in FIG. 4, the power indicator apparatus 22 may be positioned between the outer layer 20 and the battery 12 so that when the outer layer 20 is shrink-wrapped or otherwise secured to the battery 12, the power indicator apparatus 22 may be positioned and secured proximate or adjacent to the battery 12, with the mechanical switch 26 located between the electrical conductor 24 and the battery 12. As illustrated in FIG. 3A, the features 30 of the electrical conductor 24 may extend beyond the mechanical switch 26 such that when the battery assembly 10 is assembled, the features 30 may be generally placed in continuous contact with the second end cap 18, which may be arranged to be the negative terminal of the battery 12.

The mechanical switch 26 may be arranged to selectively insulate the remainder of the electrical conductor 24 from the casing 14 and positive terminal of the battery 12. In such an arrangement, during normal use of the battery assembly 10, no electrical current passes through the electrical conductor 24. However, when a user wants an indication of the energy remaining in the battery 12, the user can manually manipulate the mechanical switch 26 such that a portion of the electrical conductor 24 engages the casing 14 though the aperture(s) 32, wherein the casing 14 forms a portion of the positive terminal of the battery 12. The contact with the positive terminal of the battery 12 completes a circuit through the electrical conductor 24 and causes an electrical current to flow through the electrical conductor 24. The magnitude of the electrical current through the electrical conductor 24 may be dependent upon and, therefore, indicative of, the amount of energy remaining or stored in the battery 12.

Electrical current flowing though the electrical conductor 24 may generate heat in the electrical conductor 24. As illustrated in FIG. 3B, the body 28 of the electrical conductor 24 may be tapered, with the width of the electrical conductor 24 varying along its length. Narrow portions of the body 28 may rise to a higher temperature under a given current than broader portions of the body 28. A thermochromatic material may be positioned in contact with or proximate to the electrical conductor 24. The thermochromatic material may be arranged so that heat generated by the electrical conductor 24 can be transferred to the thermochromatic material. The thermochromatic material may respond to the transfer of heat by changing color in proportion to a temperature of the thermochromatic material. It will be understood that the tapered configuration of the electrical conductor 24, the position of the thermochromatic layer relative to the electrical conductor 24, and/or the configuration of the thermochromatic layer may be arranged to result in a visual indication 34 to a user that corresponds with the amount of energy remaining in the battery assembly 10 (FIGS. 6 and 10-22). Such calibrated charge indicators 34 may be employed in combination with either one- or two-touch power indicator apparatus 22.

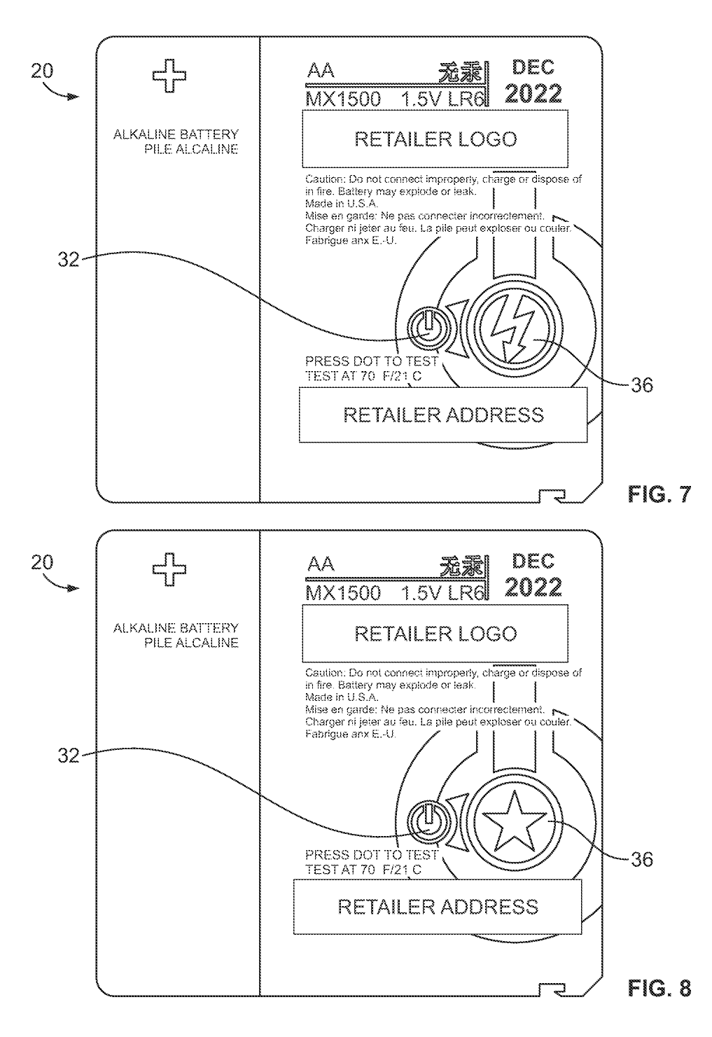

In another embodiment, rather than providing an indication of the amount of energy remaining in the battery assembly 10, the power indicator apparatus 22 may be configured as a non-calibrated pass/fail indicator. If there is energy remaining in the battery or at least energy above a particular threshold, a visual indicator 36 (e.g., a change in color) may show the battery assembly 10 to be in a “charged” or “energized” condition. On the other hand, if there is no energy remaining in the battery or if the amount of energy falls below a particular threshold, the visual indicator 36 may be configured to not provide the aforementioned indication (e.g., by not changing color). Exemplary battery assemblies 10 incorporating such a non-calibrated charge indicator 36 are illustrated in FIGS. 7-9. Such non-calibrated charge indicators 36 may be employed in combination with either one- or two-touch power indicator apparatus 22.

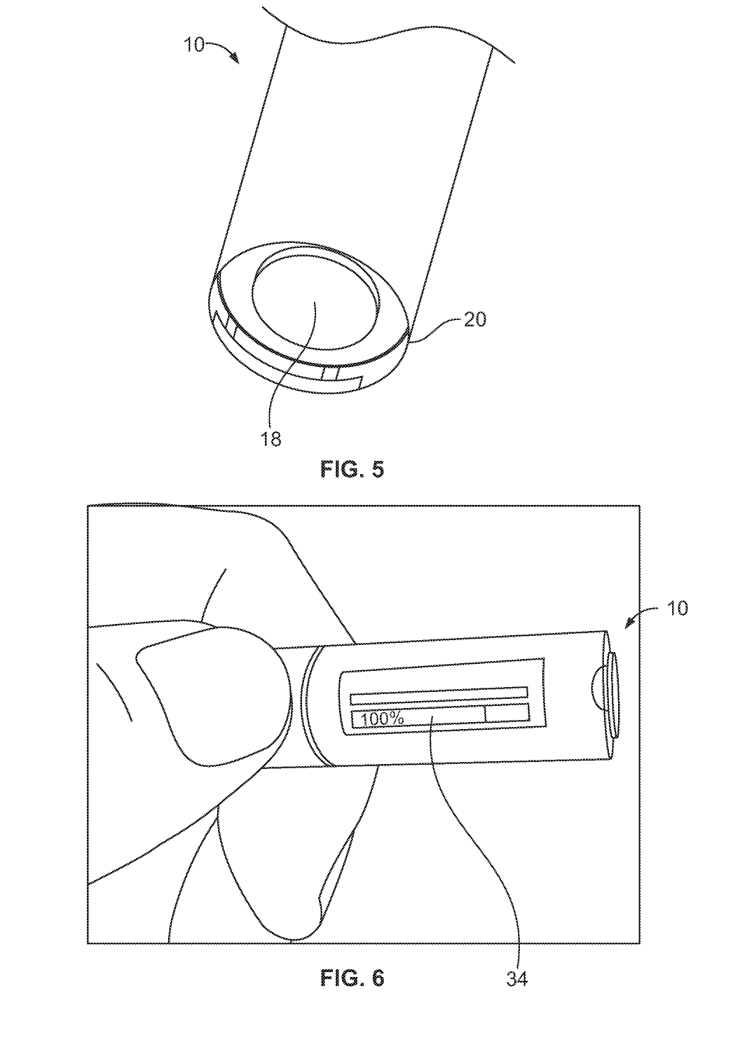

The power indicator apparatus 22 may be attached to the label 20, and the label 20 can be attached to the casing 14. The position of the power indicator apparatus 22 relative to the casing 14 may therefore be determined by the manner in which the label 20 is shrink-wrapped or otherwise secured to the casing 14. When the label 20 comprises a polymeric shrink wrap film that shrinks to fit around the casing 14 upon heating, the position of the power indicator apparatus 22 with respect to the pre-shrunk label 20 may determine the position of the power indicator apparatus 22 relative to the casing 14 after the label 20 is shrunk. In particular, the position of the power indicator apparatus 22 may determine if a portion of the electrical conductor 24 will generally remain in continuous contact with one of the terminals (e.g., the negative terminal) of the battery 12 upon shrinking of the label 20. As seen in FIG. 5, prior to the shrinking of the label 20, a portion of the label 20 may extend beyond the second end cap 18. As the label 20 shrinks, the portion of the label 20 extending beyond the second end cap 18 of the battery 12 can wrap around to cover a portion of the second end cap 18. By careful positioning of the electrical conductor 24 relative to the label 20, the position of the electrical conductor 24 relative to the second end cap 18 upon shrink-wrapping of the label 20 may be controlled.

A number of variables may be controlled to vary the final positioning of the power indicator apparatus 22 relative to the casing 14. For example, a portion of the electrical conductor 24 (i.e., the features 30) may generally extend beyond the mechanical switch 26 as illustrated in FIG. 3A, for example. The arrangement of the extension of the electrical conductor 24 beyond the mechanical switch 26 may determine how large a portion of the electrical conductor 24 is in contact with the second end cap 18 upon shrink-wrapping of the label 20. In other embodiments, the portion or features 30 of the electrical conductor 24 that do extend beyond the mechanical switch 26 may be arranged in various geometries.

An example of the power indicator apparatus 22 positioned on the label 20 prior to shrink-wrapping on the battery 12 is illustrated in FIG. 4. The end of the electrical conductor 24 is positioned to generally align with or extend slightly beyond the edge of the label 20. The illustrated electrical conductor 24 includes three features or tabs 30 that extend beyond the mechanical switch 26. As the label 20 shrinks, a portion of the label 20 wraps around the second end cap 18 and generally conforms to the shape of the second end cap 18. The features or tabs 30 may also be wrapped around the second end cap 18 by the shrinking of the label 20, and the features or tabs 30 can be placed in contact with the second end cap 18, which can be arranged as the negative terminal of the battery 12. This contact can be generally maintained continuously due to the conforming of the label 20 to the contours of the casing 14. A portion of the mechanical switch 26 may also wrap around the second end cap 18 to cover at least a portion of the second end cap 18. Such an arrangement may guard against a portion of the electrical conductor 24 coming into contact with the casing 14, which can be arranged to be part of one of the terminals (e.g., the positive terminal).

The features 30 of the electrical conductor 24 may be configured in a variety of suitable arrangements to facilitate electrical communication for a variety of different batteries. Batteries may have different geometries, different positive and/or negative terminals, and/or different material compositions. The electrical conductor 24, the features 30 of the electrical conductor 24, the mechanical switch 26, and/or the label 20 may be arranged so as to form a generally continuous electrical contact with the positive or negative terminal of the battery 12 upon the shrink-wrapping of the label 20 to the casing 14.

In one embodiment, prior to the shrink-wrapping of the label 20 to the casing 14, a conductive adhesive may be applied to the exposed portion of the electrical conductor 24 and/or to the second end cap 18. Upon the shrink-wrapping of the label 20, the conductive adhesive may bond the electrical conductor 24 to the second end cap 18. Such bonding may further maintain continuous contact between the second end cap 18, which may be configured to be one of the terminals of the battery 12, and the electrical conductor 24. Although the electrical conductor 24 is described as generally remaining in contact with the second end cap 18 of the battery 12 and selectively engaging with the opposite terminal of the battery 12, it will be understood that the electrical conductor 24 can alternatively be arranged so that the electrical conductor 24 generally remains in contact with the positive terminal or first end cap 16 and is selectively engaged with the opposite or negative terminal.

The power indicator apparatus 22 has heretofore been described and illustrated to include multiple separate components. It will be understood that two or more of the components of the power indicator apparatus 22 may be manufactured together, or that any component may be an assembly of multiple subcomponents. In one example, all the components of the power indicator apparatus 22 may be printed onto a substrate. In another example, the electrical conductor 24 may be printed onto the mechanical switch 26 or to another insulative component. In addition, adhesives may be used to secure the power indicator apparatus 22 or individual components thereof to the label 20 or to the casing 14 of the battery 12.

FIGS. 6-6B illustrate a user initiating a reading of potential energy remaining in the battery assembly 10, with FIG. 6A showing the battery assembly 10 prior to manipulation by a user. In the embodiment of FIGS. 6-6B, the user initiates the reading by placing pressure at a single point, such as a button or designated area, on the mechanical switch 26. The user can apply pressure using a single digit, in this case the user's thumb. Pressure is applied at a location on the label 20 that corresponds with the location of the aperture 32 of the mechanical switch 26 that is positioned under the label 20 and proximate to the casing 14 (FIG. 6B). The location along the label 20 that initiates a reading may be marked for the user by a graphic on the label 20 illustrating where pressure should be applied. The power indicator apparatus 22 may be arranged so that when pressure is placed adjacent to the aperture 32 of the mechanical switch 26, the electrical conductor 24 and/or the mechanical switch 26 deflects and the electrical conductor 24 physically engages the casing 14 through the aperture 32 (FIG. 6B). Thus, a circuit is completed through the electrical conductor 24. Such an arrangement allows for the user to selectively actuate the power indicator apparatus 22 to initiate a reading. As illustrated in FIG. 6, a dynamic graphic or calibrated indicator 34 on the label 20 may display a reading that estimates the amount of potential energy stored in the battery 12.

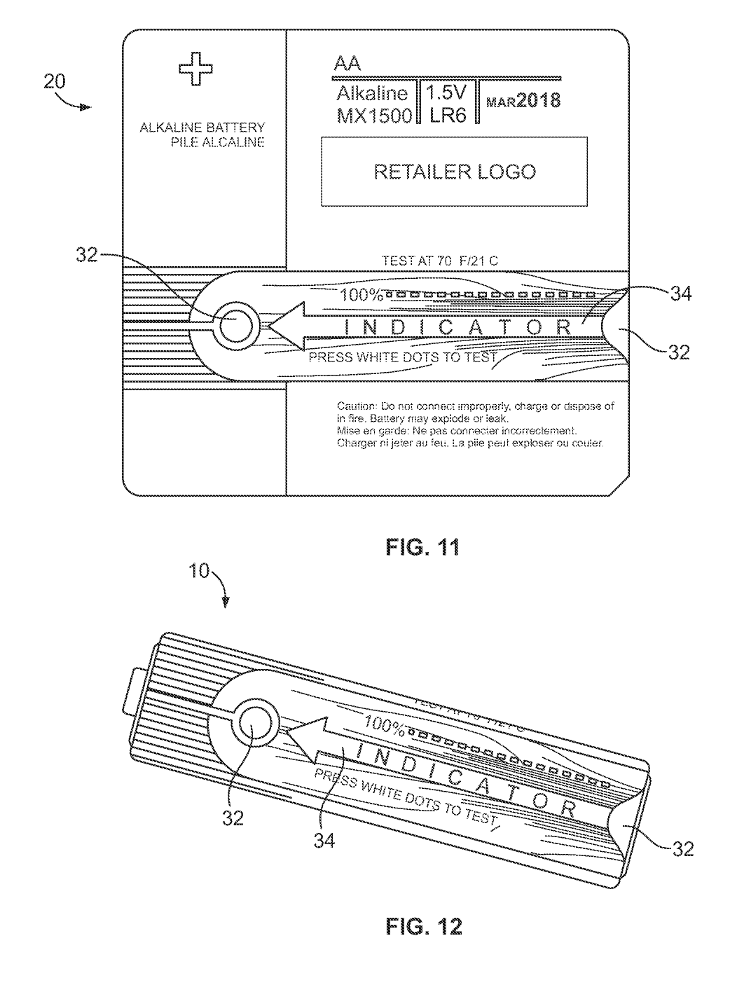

FIGS. 7-9 illustrate other embodiments of a one-touch power indicator configuration. The embodiments of FIGS. 7-9 differ from the embodiment of FIG. 6 in that they employ a non-calibrated charge indicator 36 instead of the calibrated indicator 34 of FIG. 6, as described above. In comparison to a calibrated indicator 34, a non-calibrated indicator 36 is relatively simple, making it better suited for representation by a larger graphic, which may be preferred by people with diminished eyesight. Additionally, it will be seen that the distance between the aperture 32 and the associated non-calibrated indicator 36 may be relatively short, compared to the distance between the apertures 32 of calibrated indicators 34 in some embodiments (as in FIGS. 10 and 11, for example). By providing a relatively short power indicator, the functional components of the power indicator may be smaller and/or shorter than in such longer calibrated indicators. For example, in one embodiment, the functional components of a non-calibrated indicator 36 may be as much as 42% shorter (in the direction between the end caps of the battery) than the functional components of a longer calibrated indicator (which are illustrated in FIGS. 3A-3C). However, it should be understood that relatively short functional components are not limited to non-calibrated indicators, but may also be employed in combination with shorter calibrated indicators.

FIGS. 3D-3K show several examples of alternative electrical conductors 24d-24k, which may be incorporated into one- and two-touch indicators and may be shorter and/or smaller than the embodiment of FIG. 3B. The illustrated embodiments are merely exemplary, and it should be understood that differently configured electrical conductors (including a smaller and/or shorter version of the electrical conductor 24 of FIG. 3B) may be employed without departing from the scope of the present disclosure.

The size of the electrical conductor (which may include its length, width, and/or thickness) determines its electrical properties and, in general, a smaller electrical conductor will have a lower resistance and higher current draw than a larger electrical conductor. A smaller electrical conductor may also generate more heat than a larger electrical conductor. Various factors may influence the size of the electrical conductor selected for use in the power indicator apparatus. For example, if it is desired for the electrical conductor to generate no more than a particular amount of heat or to have a defined maximum current draw, then it limits the minimum allowable size of the electrical conductor. On the other hand, if the graphics on the associated battery label 20 are relatively small or short, then that may be a limit on the maximum suitable size of the electrical conductor. Cost may also be a factor, in which case a smaller or shorter electrical conductor is generally less expensive than a larger or longer electrical conductor.

The embodiments of FIGS. 3D-3H (and the embodiment of FIG. 3B) include a tapered portion, which will generate a varying amount of heat along the length of the electrical conductor. When used in combination with thermochromic material, the resulting display is a color gradient that may be advantageous for use in a calibrated indicator. In contrast, the embodiments of FIGS. 3J and 3K have substantially uniform widths along their respective lengths, meaning that they generate a substantially uniform amount of heat along their respective lengths. When used in combination with thermochromic material, the indicator will either generate a graphical display indicative of sufficient charge remaining in the associated battery or no such graphical display (when the voltage is sufficiently low that the battery should be replaced or recharged), rendering such electrical conductors particularly advantageous for use in non-calibrated indicators. However, it should be understood that tapered electrical conductors may be employed in non-calibrated indicators and that non-tapered electrical conductors may be employed in calibrated indicators.

The embodiments of FIG. 7-9 illustrate how the non-calibrated indicator 36 may include a graphic or visual indicia, which may be configured to change appearance (e.g., by changing color) upon actuation by a user to indicate that there is charge remaining in the battery. The various embodiments illustrate how the non-calibrated indicator 36, depending on the nature of the visual indicia provided therewith, may provide a plurality of simultaneous functions, such as a branding or promotional function, in which a trademark or logo or a symbol otherwise relevant to a contest or event is incorporated into the indicator 36. The embodiments of FIGS. 6-9 are merely exemplary of one-touch power indicator configurations and other configurations may also be employed without departing from the scope of the present disclosure.

FIGS. 10-22 illustrate embodiments of labels 20 and battery assemblies 10 incorporating two-touch power indicator technology. The illustrated embodiments of FIGS. 10-22 incorporate calibrated indicators 34, which provide more information than non-calibrated indicators 36 (as in FIGS. 7-9), but may be more difficult for a user to see. The embodiments of FIGS. 10-22 incorporate labels 20 with calibrated indicators 34 configured for improved visibility.

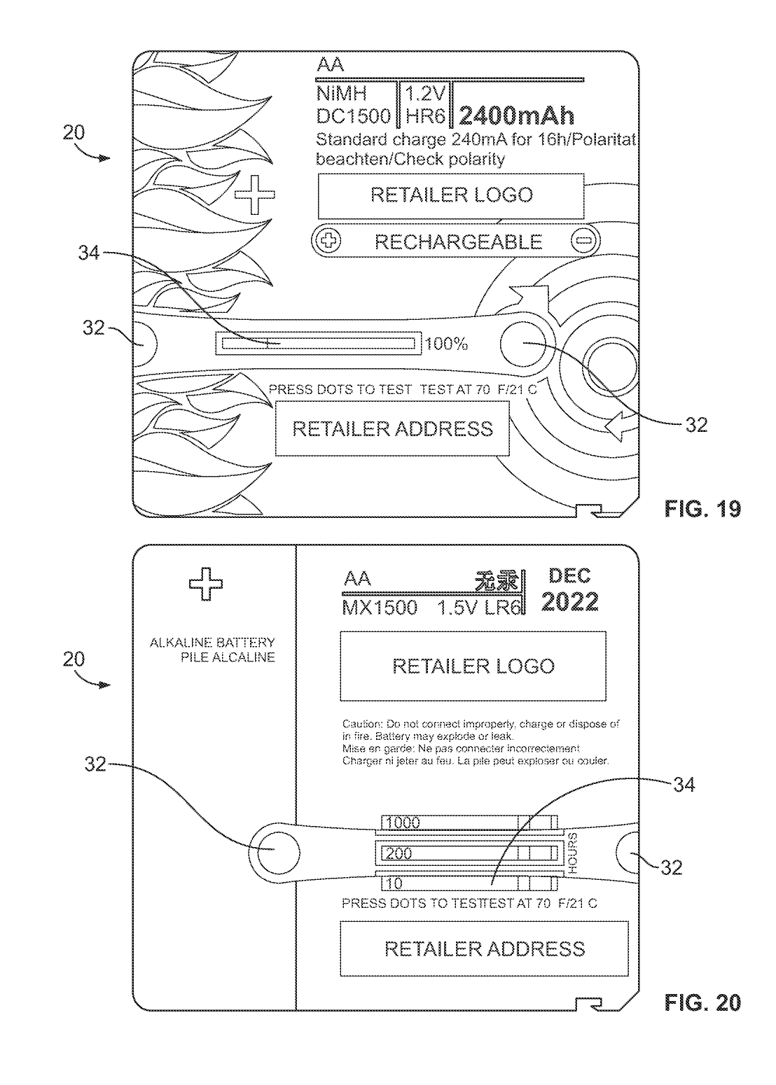

In the embodiment of FIG. 10, the calibrated indicator 34 has four graphics spaced along its length to show when the battery is at full charge, ¾ charge, ½ charge, or ¼ charge. In other embodiments, there may be more or fewer graphics and/or different graphics (e.g., full charge, ⅔ charge, and ⅓ charge or 75% charge, 50% charge, and 25% charge). FIGS. 11-19 illustrate other examples of labels 20 and battery assemblies 10 which are differently configured to provide the associated calibrated indicator 34 with improved visibility. The embodiment of FIG. 19 illustrates a label 20 for a rechargeable battery assembly, which will be described in greater detail below in connection with a charger.

More particularly, the calibrated indicator 34 of FIGS. 11 and 12 includes a logo underneath a plurality of dashes or line segments. The dashes or line segments are substantially identical to each other and are arranged in an array or a line substantially parallel to the calibrated indicator 34. Depending on the charge remaining in the battery, all or a portion of the logo will change appearance (e.g., changing color) to indicate the amount of charge remaining when the apertures 32 are actuated by a user. If the battery is fully charged, all or substantially all of the logo will change appearance to indicate a full or substantially full charge. On the other hand, if the battery is only partially charged, only a portion of the logo (e.g., a right side of the logo) will change appearance, with the other portion (e.g., a left side of the logo) will undergo no such change, thereby indicating that the battery is not fully charged. Preferably, the percentage of the logo that changes appearance corresponds to the percentage of charge remaining in the battery, such that a user can more accurately assess the remaining usable life of the battery.

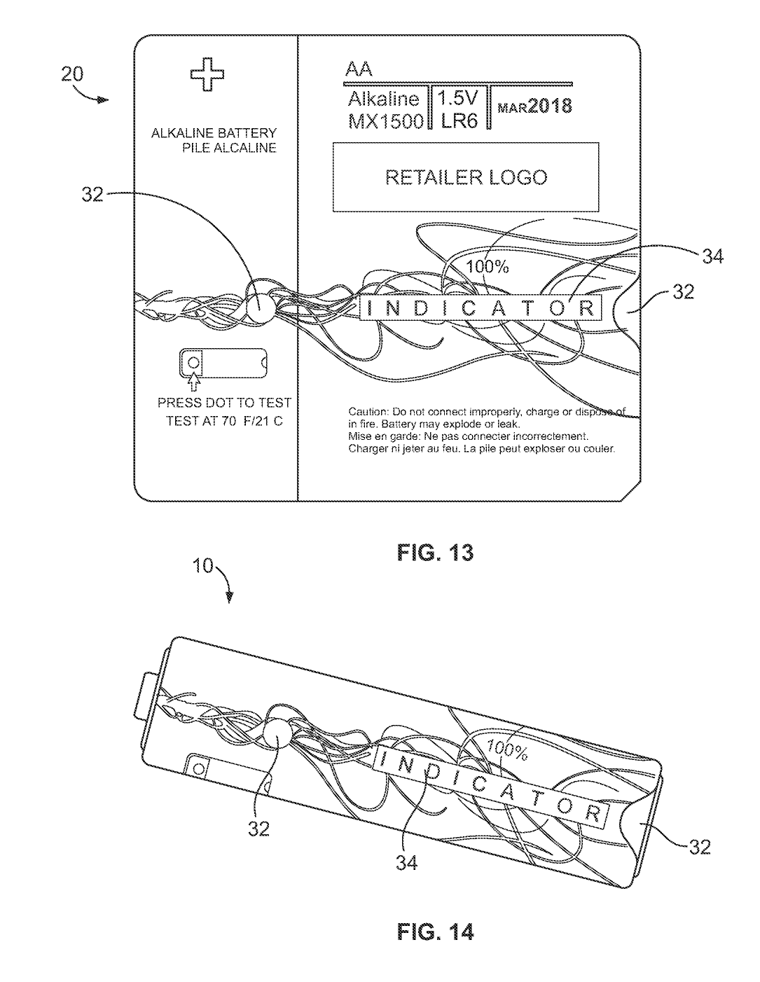

The calibrated indicator 34 of FIGS. 13 and 14 is similar to that of FIGS. 11 and 12, in that it includes a logo, but differs in omitting dashes or line segments positioned adjacent to the logo. As in the embodiment of FIGS. 11 and 12, at least a portion of the logo will change appearance to indicate the amount of charge remaining when the apertures 32 are actuated. In the illustrated embodiment, only a portion of the logo changes appearance to indicate that the battery is fully charged, as indicated by the “100%” icon located at an intermediate portion of the logo (as compared to FIGS. 11 and 12, in which a “100%” icon is located at the left end of the logo). For example, the left portion of the logo may be configured to have a uniform appearance during testing, while the right portion of the logo is configured to change appearance during testing to indicate the amount of charge remaining. However, it is also within the scope of the present disclosure for the entire logo to be configured to change appearance to indicate that the battery is fully charged, as in other embodiments.

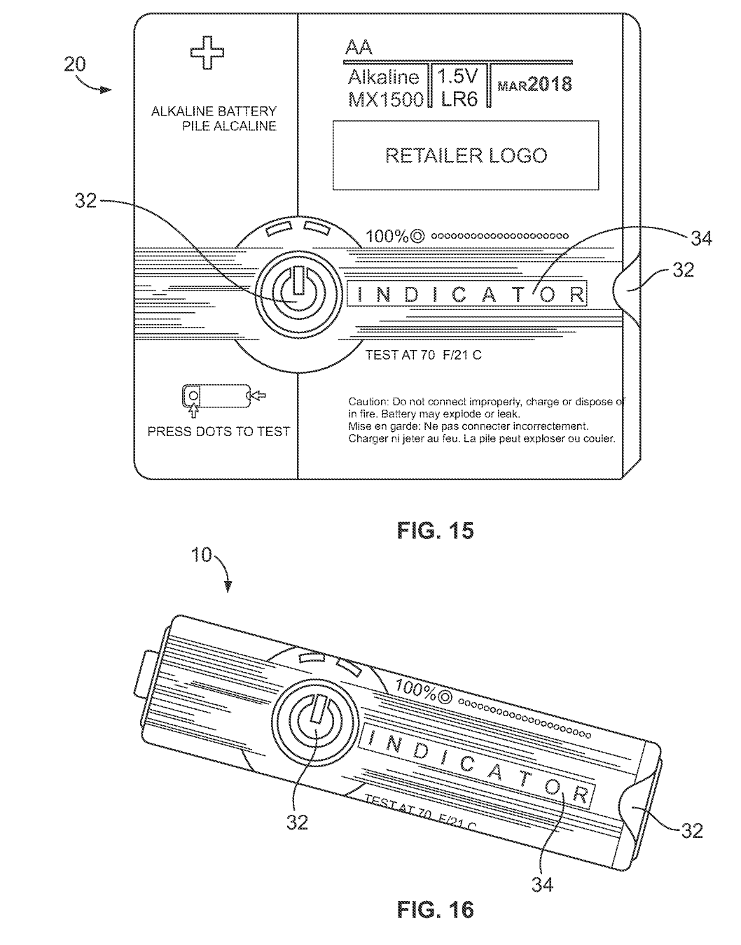

The calibrated indicator 34 of FIGS. 15 and 16 is similar to the embodiment of FIGS. 11 and 12, in that it includes a logo, but differs in employing a line of circles instead of dashes or line segments positioned adjacent to the logo. In addition to circles and dashes or line segments, a line or array of other geometric shapes or the like may be employed. At the left end of the line of circles are a “100%” icon and a circle surrounded by a concentric ring. The circle and ring indicates a full charge of the battery such that, when a fully charged battery is tested, the logo changes appearance up to the location of the circle and ring. Similar to the embodiment of FIGS. 13 and 14, only a portion of the logo will change appearance when a fully charged battery is tested, such that the circle and ring are located adjacent to an intermediate portion of the logo, rather than at one of its ends.

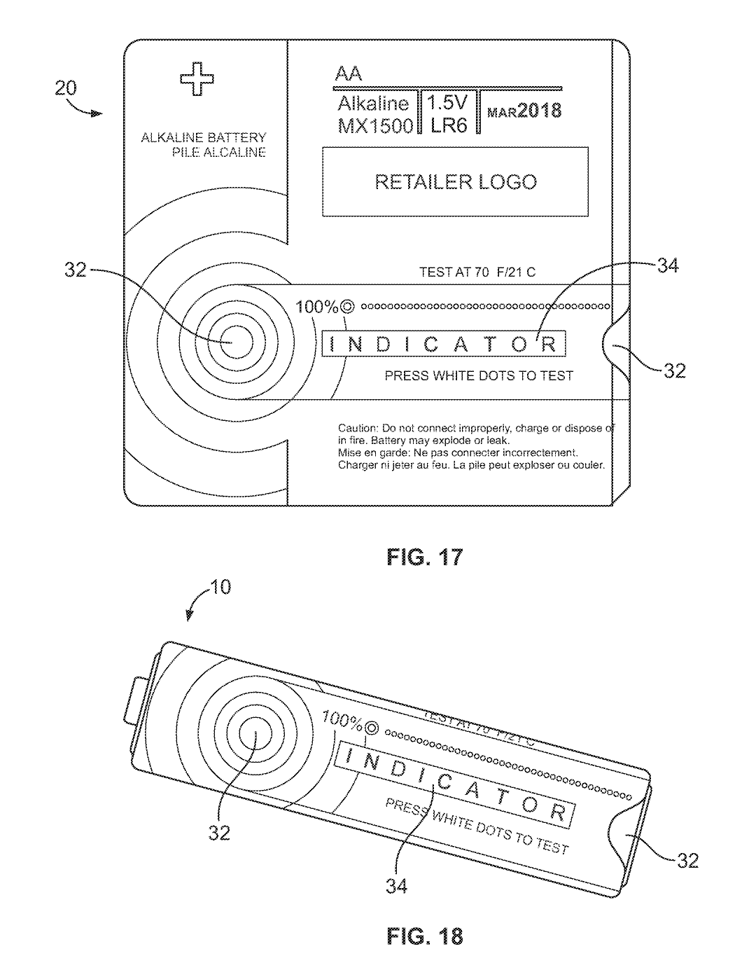

The calibrated indicator 34 of FIGS. 17 and 18 is similar to the embodiment of FIGS. 15 and 16, in that it includes a logo with a line of circles positioned adjacent thereto and a “100%” icon and a circle and ring located at an end of the line of circles. In contrast to the embodiment of FIGS. 15 and 16, the “100%” icon and circle and ring are located at an end of the logo to indicate that the entire logo will change appearance when a fully charged battery is tested.

As for the calibrated indicator 34 of FIG. 19, rather than employing a logo (as in the embodiments of FIGS. 11-18), it includes an empty space in which a colored bar appears during testing to indicate the amount of charge in the battery (as in the embodiment of FIG. 10). In contrast to the embodiments of FIGS. 10-18, the indicator illustrated in FIG. 19 has an opposite orientation, in that it is configured to change appearance from left to right (instead of right to left) to indicate the amount of charge in the battery. The orientation of any of the calibrated indicators 34 described and illustrated herein may be reversed, such that the indicators of FIGS. 10-18 may be configured to change appearance from left to right and the indicator of FIG. 19 configured to change appearance from right to left to indicate the amount of charge in the battery. Furthermore, the various individual features employed in the different indicators may be employed in other indicators (e.g., including a line of circles in the indicator of FIG. 19) without departing from the scope of the present disclosure.

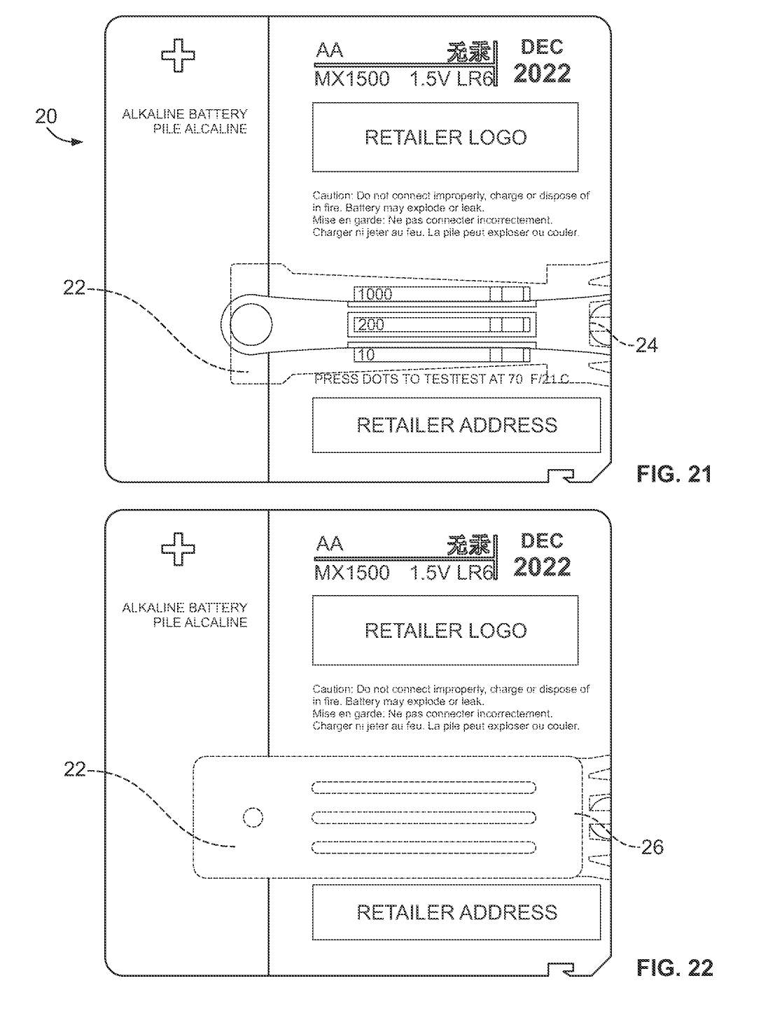

The label 20 of FIGS. 20-22 includes a plurality of separate calibrated indicators 34 which, in one embodiment, are associated with a common power indicator apparatus 22. FIG. 21 illustrates the electrical conductor 24 of the power indicator apparatus 22, while FIG. 22 illustrates the mechanical switch 26 of the power indicator apparatus 22. It will be seen that, compared to the indicator apparatus of embodiments having a single calibrated indicator (see FIGS. 3A-3C, for example), the indicator apparatus 22 of FIGS. 21 and 22 is relatively large to at least partially overlay all of the calibrated indicators 34 and may include additional features or extensions for contacting the second end cap.

In the embodiment of FIGS. 20-22, the label 20 includes three separate calibrated indicators 34, but may be provided with more of fewer. Each indicator 34 is configured to illustrate an estimate of the time that the battery assembly may be used to power a particular device. For example, a first indicator may be configured to show the time that the battery could be used to power a device requiring a relatively high amount of charge, with the maximum time being labeled as 10 hours in one embodiment. A second indicator may be configured to show the time that the battery could be used to power a device requiring a moderate amount of charge, with the maximum time being labeled as 200 hours in one embodiment. A third indicator may be configured to show the time that the battery could be used to power a device requiring a relatively low amount of charge, with the maximum time being labeled as 1000 hours in one embodiment.

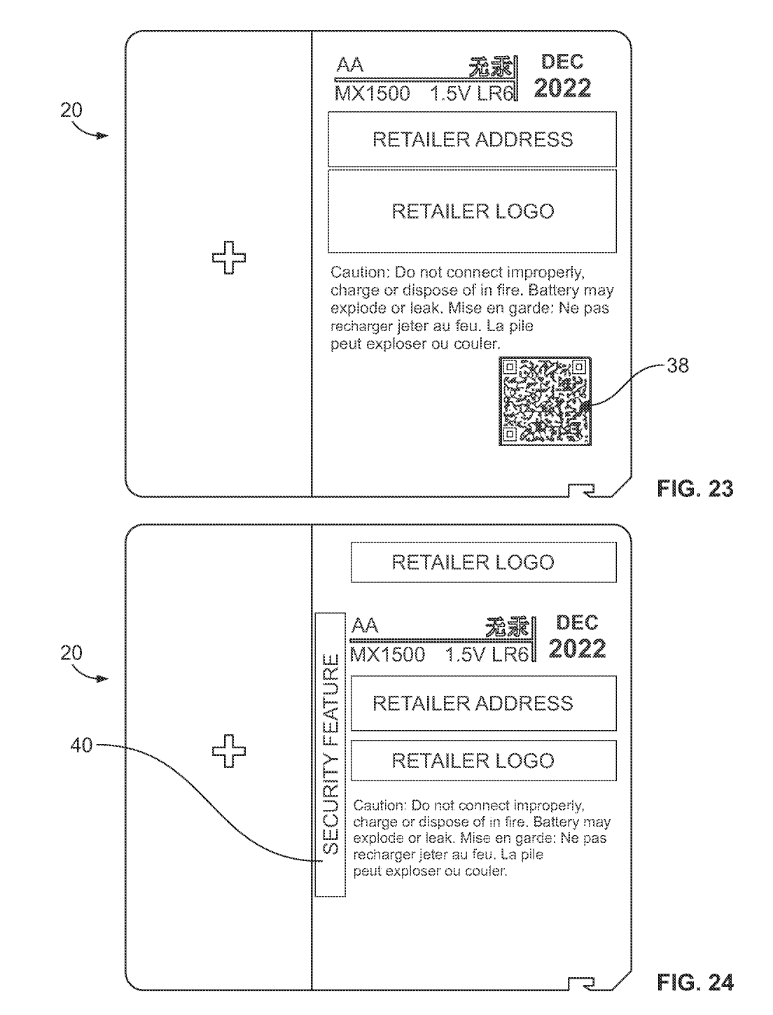

Beyond providing a charge-indicating function, the label 20 may be variously configured with alternative or additional functionality. For example, the embodiment of FIG. 23 is provided with a quick response code 38 which, when accessed by a user, may provide additional information about the device and/or the manufacturer and/or provide other content to the user (e.g., rebate offers or other promotional content). Other codes may also be incorporated into the label 20 to provide a variety of functions to a user. This aspect of the present disclosure may be used alone or in combination with the other features described herein.

In the embodiment of FIG. 24, the label 20 is provided with a security feature 40. The security feature 40 may be variously configured but, in one embodiment, may comprise a logo or graphic printed on the label in varnish or ultra-violet ink. The security feature 40 has anti-counterfeiting functionality and may prevent or deter forgeries by making it more difficult for counterfeiters to duplicate the labels 20 in a mass quantity. By providing such an anti-counterfeiting feature, the manufacturer or product brand is protected because counterfeiters cannot provide branded battery assemblies of inferior quality. This aspect of the present disclosure may be used alone or in combination with the other features described herein.

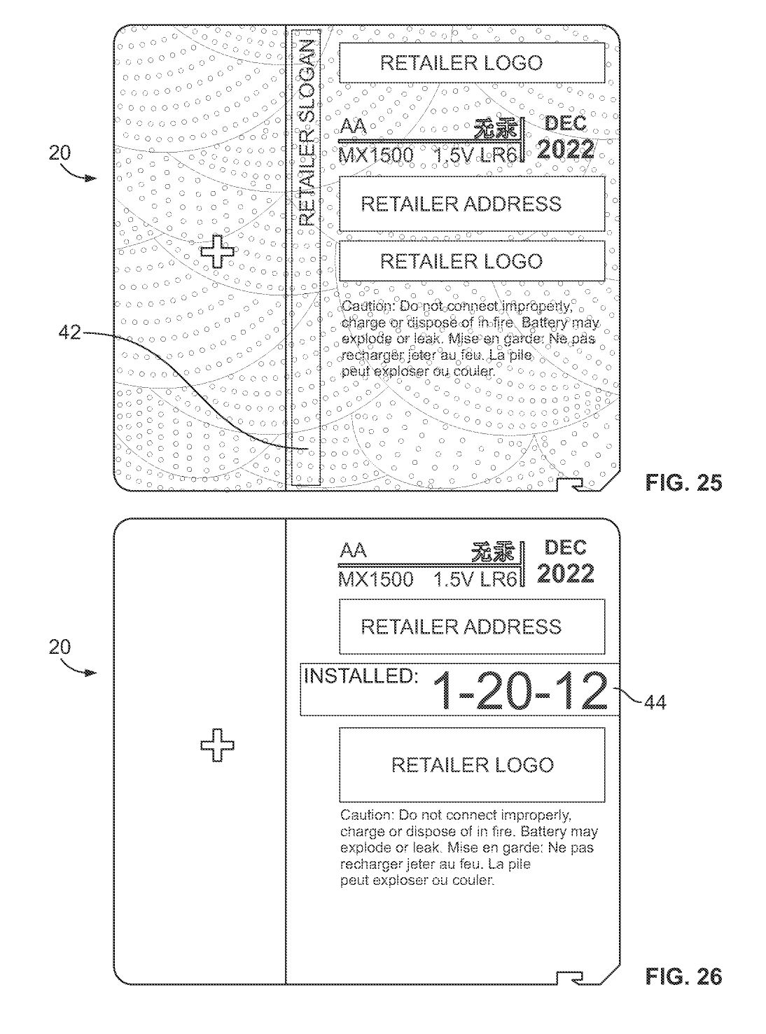

In the embodiment of FIG. 25, the label 20 is provided with absorbent or sealant properties. The label 20 may include an absorbent layer 42 or be otherwise treated with an absorbent material to prevent corrosion from a leaking battery. In one embodiment, a superabsorbent polymer is added to the adhesive used to secure the label 20 to a battery, but other approaches may also be employed without departing from the scope of the present disclosure. In another embodiment, the absorbent layer 42 may be configured to alert a user to the presence of a leak. For example, at least a portion of the absorbent layer 42 may include a material configured to react with electrolyte material leaking from a battery (e.g., potassium hydroxide) by changing its appearance, such as by changing color. This aspect of the present disclosure may be used alone or in combination with the other features described herein.

In the embodiment of FIG. 26, the label 20 is provided with an open or designated area 44 that is distinguished from other portions of the label 20. The open area 44 allows a user to write a date (e.g., the date on which the battery assembly was installed) or other information on the label 20. In the embodiment of FIG. 26, the open area 44 is white while adjacent portions of the label 20 are black or more darkly colored, but other configurations may also be employed without departing from the scope of the present disclosure. In yet another embodiment, the open area 44 may be configured of a different material than the remainder of the label 20 (or at least one other portion of the label 20) and/or be subjected to a surface treatment to render it more advantageous for use with a writing utensil. This aspect of the present disclosure may be used alone or in combination with the other features described herein.

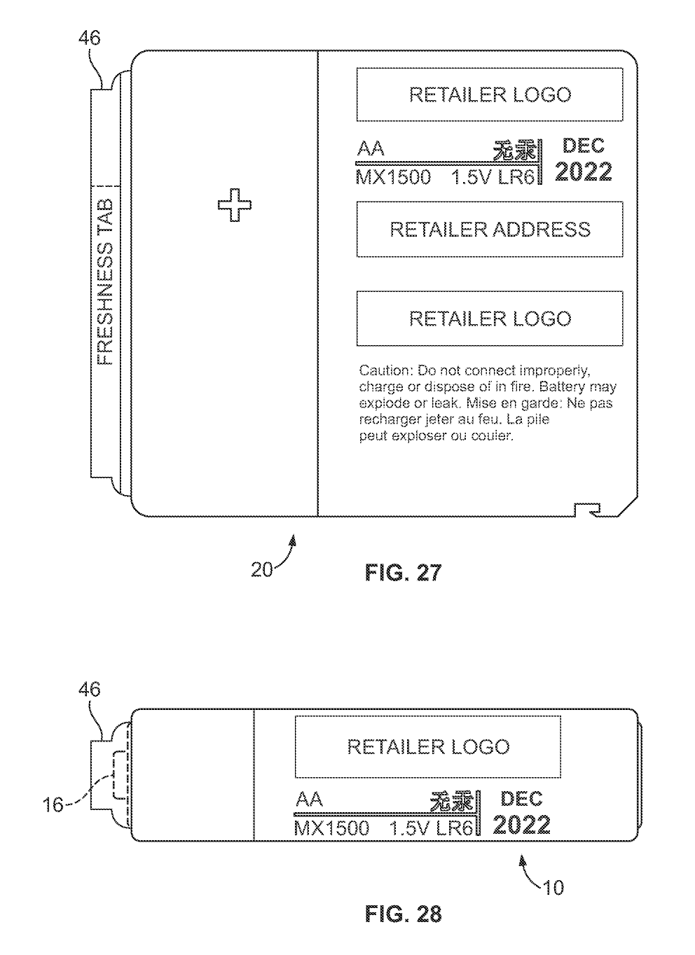

In the embodiment of FIGS. 27 and 28, the label 20 of a battery assembly 10 is provided with an extension 46 at one or both of its ends. In the embodiment of FIGS. 27 and 28, the label 20 is provided with an extension 46 at the end configured to be associated with the first end cap 16. The extension 46 serves as a visually observable freshness or tamper-resistant indicator or tab. When the label 20 has been applied to a battery, the extension 46 forms a ring or collar or sleeve at least partially around the associated end cap of the battery. The battery assembly 10 cannot be used without damaging or removing the extension 46. Accordingly, a user will know just by looking at the battery assembly 10 whether it has been used before or if it unused. In one embodiment, the extension 46 may be configured to be readily removed by a user, such as by providing a frangible connection or perforation line between the extension 46 and the remainder of the label 20. This allows a user to easily remove the extension 46 from the battery assembly 10 prior to using the battery assembly 10. The extension 46 may be provided with additional functionality, such as a redemption code or the like which allows the user to get a discount on a future purchase by entering the code or exchanging or redeeming the extension 46 itself with a retailer or the manufacturer. This aspect of the present disclosure may be used alone or in combination with the other features described herein, but may be particularly advantageous when used in combination with a battery assembly 10 omitting a charge indicator.

In other embodiments, the label 20 may be modified to include various sensory-type elements relating to touch, feel, and/or sight. For each element, it is desired that these sensory-type elements work on a label which has been applied to an electrochemical (battery) cell (hereinafter referred to as a battery label). Sensory-type elements which can be incorporated into a battery label include, but are not limited to, those which provide an enhanced sensation to touch/feel (touch-type) and those which provide an enhanced sensation to sight (visual or sight type). These elements may be practiced alone or together and may be used in combination with or separately from the other features and embodiments described herein.

Touch-type sensory elements can include, but are not limited to, elements which provide effects (such as textured or roughened surfaces) which enable a user to better grip the surface of a battery, those which enable a user to detect the location of a power indicator or tester or the respective poles of a battery (such as raised surfaces or surfaces made of a different material than the rest of the label). Various methods can be used to impart touch-type sensory elements to a battery label material. Such methods include, but are not limited to, tactile coatings, film embossing and surface manipulation of various topcoats. For example, a tactile surface can be applied to the battery label to enable better grip of the battery and secondarily provide a different customer interaction. Such tactile feels can be imparted to the battery surface by embossing the label using either thermal or UV embossing techniques. In case of thermal embossing, the original label may be directly embossed or optionally a separate material can be incorporated as the embossing surface. A further exemplary method is to use a UV clear top coating that is embossed while cured to provide the desired relief structure. Alternatively the tactile coating can be applied as a screen print coating. Further clear topcoats with different gloss can be applied to the surface of a label to create a matte-surface finish or a surface finish with varied gloss. This effect can be imported with typical printing methods such as gravure, flexo, digital or screen printing.

Visual (sight)—type sensory elements can include, but are not limited to, effects which enable a user to visually identify various aspects of a battery cell such as the polar ends, a power indicator or tester, the brand, and the like, as well as those which enable a user to identify those same elements in an environment where no light or low light is present. These visual effects can be imparted to the battery label material alone or in conjunction with the touch-type sensory effects. The visual effects can be accomplished by including metal foils, holographic elements, cast coated layers, phosphorescent inks, glow-in-the-dark inks and the like into or onto the label material, before or after application of the label material to the battery. Conventional materials and methods for achieving the visual effects can be employed for this application with the limitation being that such materials and methods result in a product which maintains its intended effect after the battery label is shaped to an electrochemical cell.

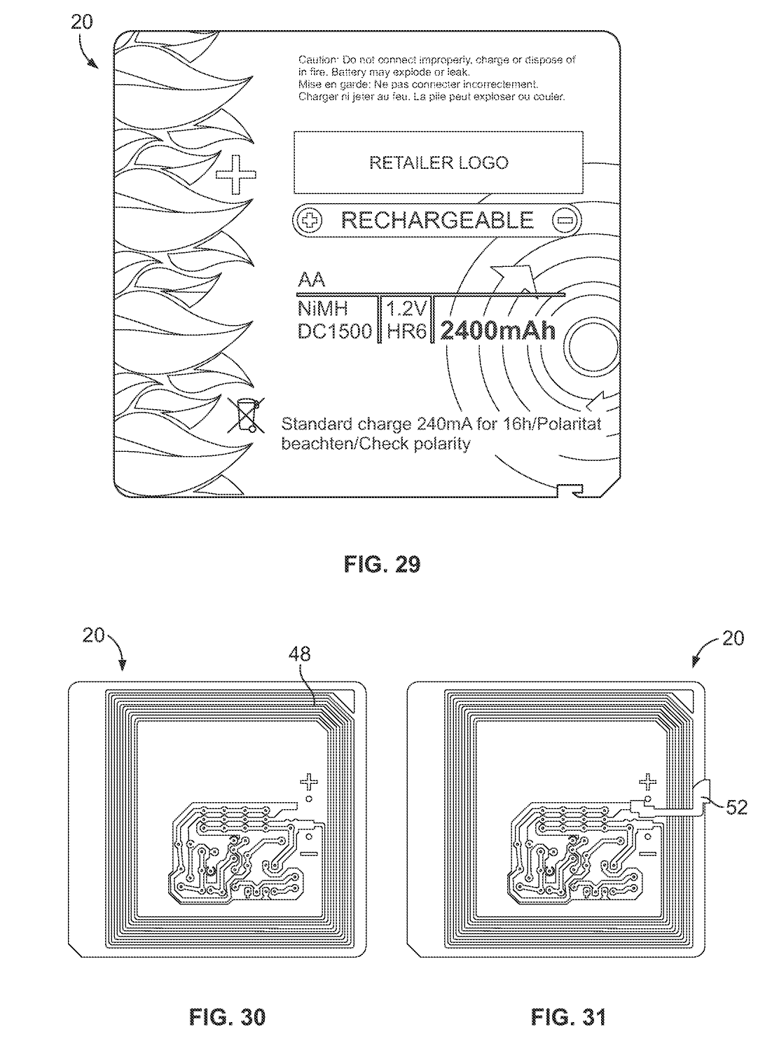

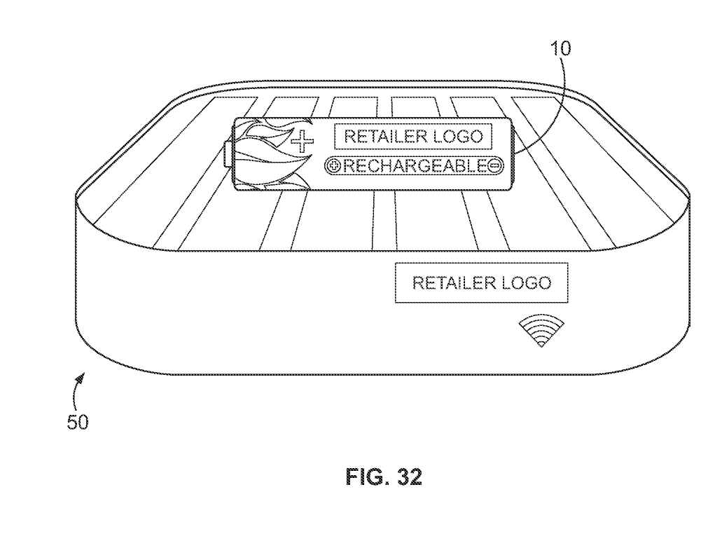

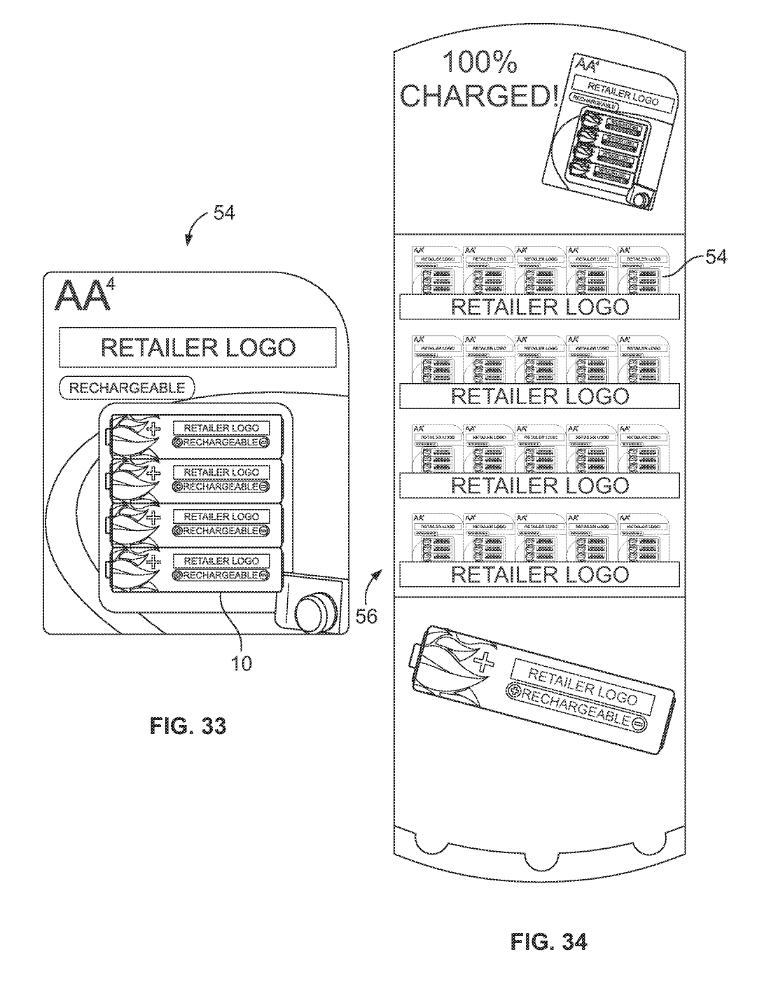

According to another aspect of the present disclosure, the labels and features described herein may be used in combination with a rechargeable battery assembly. In particular, the labels 20 of FIGS. 19 and 29-31 are specially configured for use in combination with a rechargeable battery assembly 10 (FIGS. 32-33). In the embodiment of FIGS. 19 and 29-31, the label 20 is provided with a printed circuit or antenna 48 (FIG. 30) that may incorporate remote frequency identification (“RFID”) technology capable of harvesting energy or charge from an associated pad or charger 50 (FIG. 32), thereby increasing the amount of charge or energy stored within the battery assembly 10. FIG. 30 shows the circuit or antenna 48 in greater detail, with the illustrated circuit or antenna 48 comprising a multi-turn copper or aluminum antenna with a flat printed rectifier, although the illustrated configuration is merely exemplary. FIG. 31 shows an exemplary printed insulator or bridge 52 that may be associated with the circuit or antenna 48. As shown in FIG. 30-31, the circuit or antenna 48 and the insulator or bridge 52 may be attached to an underside of the label 20 (e.g., by crimping or soldering or chemical bonding or the like) such that they (or at least a portion thereof) are configured to be placed in contact with the battery 12 when the label 20 is secured thereto.

The rechargeable battery assembly 10 (which may comprise a rechargeable battery assembly for use in a cellular telephone) may be recharged by placing it on a pad or charger 50 of the type shown in FIG. 32. The charger 50 may be relatively small (e.g., being sized to accommodate only one or a small number of battery assemblies 10), allowing it to easily fit on a desk or tabletop during use. In one embodiment, the charger 50 is portable, allowing it to be used in one location (e.g., at a user's home) and then readily moved to a different location (e.g., at a user's office) for subsequent use.

When the charger 50 is connected to a power source (via a power cord, which may comprise a USB plug at one end and an electrical outlet plug at the other end in one embodiment), it emits a signal that is received by the circuit 48 when the battery assembly 10 is positioned on the charger 50. The circuit 48 converts the signal into stored energy within the battery assembly 10. In one embodiment, the charger 50 is configured to charge the battery assembly 10 by inductive charging, in which case it may emit a signal having a frequency on the order of approximately 915 Mhz (also known as the “Qi” norm). In another embodiment, the charger 50 is configured to charge the battery assembly 10 using a standard IEEE 802.11 Wifi signal, which may have a frequency on the order of approximately 2.4 Ghz. Other signals (e.g., a signal having a frequency on the order of approximately 13.56 Mhz) may also be employed without departing from the scope of the present disclosure. The circuit 48 may be configured to charge the battery assembly 10 at any suitable power, but in one embodiment, charges the battery assembly 10 at approximately 1-4 watts (with an internal resistance of approximately 50 ohms).

Other chargers may also be used to re-energize rechargeable battery assemblies according to the present disclosure. For example, FIG. 33 shows a package or container 54 containing one or more rechargeable battery assemblies 10. A point-of-sale display unit 56 (FIG. 34) may be provided to hold one or more of the packages 54 at a retail location. The display unit 56 may include one or more built-in charger that (when the display unit 56 is connected to a power supply) energizes the rechargeable battery assemblies 10 when the display unit 56 is loaded with packages 54. In one embodiment, the built-in charger of the display unit 56 comprises a charger 50 of the type illustrated in FIG. 50, but other chargers may also be employed without departing from the scope of the present disclosure. Incorporating one or more chargers into the display unit 56 ensures that the battery assemblies 10 are fully charged when they are purchased by a customer.

It will be understood that the embodiments described above are illustrative of some of the applications of the principles of the present subject matter. Numerous modifications may be made by those skilled in the art without departing from the spirit and scope of the claimed subject matter, including those combinations of features that are individually disclosed or claimed herein. For these reasons, the scope hereof is not limited to the above description but is as set forth in the following claims, and it is understood that claims may be directed to the features hereof, including as combinations of features that are individually disclosed or claimed herein.

1. A rechargeable battery assembly label comprising a circuit or antenna configured to receive a remote frequency identification signal for increasing the amount of energy or charge of a battery associated with the rechargeable battery assembly label.

2. The rechargeable battery assembly label of claim 1, wherein the circuit or antenna comprises a printed circuit or antenna.

3. The rechargeable battery assembly label of claim 1, wherein the circuit or antenna comprises multi-turn copper or aluminum antenna with a flat printed rectifier.

4. The rechargeable battery assembly label of claim 1, further comprising a printed insulator or bridge associated with the circuit or antenna.

5. The rechargeable battery assembly label of claim 1, wherein the circuit or antenna is attached to an underside of the rechargeable battery assembly label.

6. The rechargeable battery assembly label of claim 1, wherein the circuit or antenna is attached to the rechargeable battery assembly label by crimping.

7. The rechargeable battery assembly label of claim 1, wherein the circuit or antenna is attached to the rechargeable battery assembly label by soldering.

8. The rechargeable battery assembly label of claim 1, wherein the circuit or antenna is attached to the rechargeable battery assembly label by chemical bonding.

9. The rechargeable battery assembly label of claim 1, wherein the rechargeable battery assembly label is configured for attachment to a cellular telephone battery.

10. The rechargeable battery assembly label of claim 1, wherein the circuit or antenna is configured to increase the amount of energy or charge of a battery associated with the rechargeable battery assembly label by inductive charging.

11. The rechargeable battery assembly label of claim 1, wherein the circuit or antenna is configured to receive a standard IEEE 802.11 Wifi signal.

12. The rechargeable battery assembly label of claim 1, wherein the circuit or antenna is configured to recharge a battery associated with the rechargeable battery assembly label at approximately 1-4 watts.

13. A recharging pad for use in combination with a rechargeable battery assembly and configured to emit a signal receivable by a circuit or antenna of a rechargeable battery assembly label.

14. The recharging pad of claim 13, wherein the signal comprises a remote frequency identification signal.

15. The recharging pad of claim 13, wherein the recharging pad is configured to increase the amount of energy or charge of a battery associated with the rechargeable battery assembly label by inductive charging.

16. The recharging pad of claim 13, wherein the signal comprises a standard IEEE 802.11 Wifi signal.

17. The recharging pad of claim 13, wherein the recharging pad is portable.

18. The recharging pad of claim 13, further comprising a power cord including an electrical outlet plug and a USB plug.

19. A display unit configured to support and display at least one rechargeable battery assembly and comprising at least one recharging pad according to claim 13.

20. The display unit of claim 19, further comprising a plurality of recharging pads.
